(19) United States
(12) Patent Application Publication
(10) Pub. No.: US 2006/0191266 A1
(43) Pub. Date: Aug. 31, 2006

(54) Method for unifying light and gravity field using a linear field of gravity

(76) Inventor: Yoshitaka Goto, Hiroshimaken (JP)

Correspondence Address: Yoshitaka Goto, 14-26 Hamamati Kusatu Nishiru Hiroshimashi, Hiroshimaken, JP

(21) Appl. No.: 11/059,719

(22) Filed: Feb. 17, 2005

(51) Int. Cl. F03G 7/00

(52) U.S. Cl. 60/721

(57) ABSTRACT

An expanded Schrödinger wave equation is discovered that enables one to derive the relativity theory in a direct fashion. Also a method of producing graviton is developed, and gravity is provided as motive power that replaces electromagnetic force. De Broglie's material wave is generated on the basis of the kinetic momentum of an object moving through space. In this connection, one may regard an object at rest as being in motion in a direction of time axis, and may call a new wave motion generated by that motion a “reference wave motion.” Further, by assuming the wavelength of this reference wave motion to be a frame of reference for time and space, one may derive the relativity theory, and then one can find an equation of gravity field obtained from that theory to be a linear equation. Either a gravity wave that satisfies this equation or a graviton obtained by quantizing that gravity wave results from the combining of four different electromagnetic waves.

### FIELD OF THE INVENTION

This invention is concerned with the unified field theory in theoretical physics, and more particularly relates to a method for unifying light and gravity field using a linear field of gravity, which method can be utilized for a wide range of such technologies as conveying machines and tools that employ an artificially produced gravity field by making it possible to unify light and gravity field and thereby providing gravity, in lieu of electromagnetic force, as motive power.

### BACKGROUND OF THE INVENTION

With regard to theories about the unification of light and gravity field, there have been known, for example, Kaluza and Klein's five-dimension unified field theory and the superstring theory. However, although these theories can be mathematically proved correct and consistent with the reality, it has been impossible experimentally to demonstrate that they are true, nor has it been possible for them to show a method of producing graviton in a direct manner.

### SUMMARY OF THE INVENTION

In order to unify light and gravity field, one has to derive a linear equation of gravity field which can be easily solved mathematically and whose accuracy can be demonstrated. Since the equation of gravity field derived from Einstein's relativity theory is a nonlinear one, however, one must form a new theory that does not contradict his relativity theory and at the same time from which one can derive a linear equation of gravity field.

Accordingly, the inventor hereof expands Schrödinger's wave equation in quantum mechanics in order to make up such a new theory. Then one requires a frame of reference for time and space in order to formulate the relativity theory from an expanded wave equation. Time and space in the Newtonian mechanics have hitherto been used as such a frame of reference, and this frame of reference can be applied to particles but cannot be applied to wave motion.

Also, just as the general theory of relativity was established on the basis of Einstein's equivalency principle, this invention requires some principle to replace the equivalency principle. That is to say, if this principle is used as it is, the transformation of the coordinates of zero-gravity field into those of gravity field results in doing coordinate transformation with a certain rate of acceleration and, as a result, such transformation generates a nonlinear equation of gravity field. Moreover, in order to be able to employ a useful principle to replace the equivalency principle in the vicinity of an object having a gravity field, one needs must do coordinate transformation when the speed of a moving body is higher than that of light, but such a coordinate transformation is not found in Einstein's relativity theory. Furthermore, one drawback of his relativity theory is that the potential energy of universal gravitation on which he founded his equation of gravity field when deriving that equation, increases to infinity when the distance between two objects is zero.

In addition, gravity wave is considered to be a kind of electromagnetic wave because gravity wave propagates at the velocity of light. This electromagnetic wave is described by Maxwell's electromagnetic equation. Then, if a formula for doing conversion between electrical charge and mass were applied to Maxwell's electromagnetic equation, one could obtain a linear equation of gravity field from that electromagnetic equation. No one, however, has ever invented such a formula yet.

But if such a formula is invented and subsequently if there is developed a practical method of producing, from electromagnetic waves, either a gravity wave or graviton obtained by quantizing a gravity wave, then a gravity field can be generated in an artificial manner, making it possible to obtain a technology of using gravity, in lieu of electromagnetic force, as motive power. Such a practical method, however, has not yet been devised.

Accordingly the inventor hereof attempts to find an expanded Schrödinger wave equation whereby one can derive the relativity theory in a direct manner and to propose a method of producing graviton and thereby attempts providing a method for unifying light and gravity field using a linear field of gravity, which method contributes towards a wide range of such technologies as conveying machines and tools that employ an artificially produced gravity field.

Thus the present invention provides a method of using gravity, in lieu of electromagnetic force, as motive power.

Accordingly a primary object of this invention is to provide a method for unifying light and gravity field using a linear field of gravity wherein that a material particle at rest has a rest energy mc² is proved by adding, to Schrödinger's wave equation, a wave number obtained from a wave motion called a reference wave motion in De Broglie's material wave which defines the wave length of a wave motion generated by the kinetic momentum of an object moving through space, and further a wave length of said reference wave motion is employed as an index of the velocity of time and the largeness of space at a place where a material particle “m” exists to obtain a Schrödinger wave equation including an expanded time, thereby making understandable the slowing down of time of a moving body, the contraction of space and the increase of mass as demonstrated by the special theory of relativity.

Using the wave length of the above-mentioned reference wave motion as an index of the velocity of time and the largeness of space at the place where the material particle “m” exists enables one to do instantaneous coordinate transformation at an equal speed on the so-called instantaneous equivalence principle using the concept of escape velocity in astronomy, so that one may change a gravity field into a zero-gravity field.

According to one aspect of the invention, it is possible to derive Schwarzschild's line elements in the general theory of relativity by using both said instantaneous equivalence principle and the light speed in the gravity field. This demonstrates that the present invention does not conflict with the general theory of relativity.

Also, according to the present invention, when the Schwarzschild line elements have been obtained, the light speed and Planck's constant “h” are proportional to each other in a gravity field.

According to another aspect of the invention, there is derived a coordinate transformation called a super light speed Lorentz transformation that instructs one how to do coordinate transformation when the speed of a moving body is higher than that of light, by using of the wave length of the reference wave motion as an index of the velocity of time and the largeness of space at the place where the material particle “m” exists, and, further, the above-mentioned super light speed Lorentz transformation is employed to propose a modified potential of universal gravitation and to establish a modified formula for universal gravitation.

This demonstrates that a self-energy generated by the gravity of a particle having no magnitude, no size, or no dimensions coincides with rest energy without increasing to infinity. In this connection, it is a matter of course that the potential of universal gravitation should not increase infinitely even when the distance between two objects is zero.

According to a further aspect of the invention, with regard to said linear field of gravity, gravity wave is assumed to be a kind of electromagnetic wave, and a formula for making conversion between electrical charge and mass which shows that the classical self-energy of electrical charge does not grow larger, is established on that assumption. Further, the above-mentioned formula may be used to derive a linear equation of gravity field from Maxwell's electromagnetic field equations.

When said assumption is made, two electromagnetic waves with a phase difference of an angle of 90 degrees between are combined together to generate a first photon having a spin of one and, in addition, a second photon with an electric field and a magnetic field differing from said first photon by 180 degrees in its phase angle is generated. And the two photons can be combined together to obtain a graviton with a spin of two.

Thus one can derive the relativity theory from the above-mentioned reference wave motion and instantaneous equivalence principle, thereby being able to obtain a wave equation that does not contradict the relativity theory. Hence, the relativity theory explains macro phenomena while the wave equation explains micro phenomena, but the present invention enables one to explain both of the phenomena in a unified manner. For example, though the formula for universal gravitation is one of the methods of explaining macro phenomena, yet that formula is of no use when the distance between two objects is zero, since the potential energy of universal gravitation grows to infinity in that case. On the other hand, however, if one uses a modified formula for universal gravitation, that potential does not increase to infinity even in such a case and, therefore, one can explain micro phenomena as well as macro phenomena by such a modified formula.

Furthermore, according to this invention, a linear equation of gravity field can be derived from a formula for doing conversion between electrical charge and, further, there is disclosed a practical method of combining two electromagnetic waves to generate either a gravity wave or graviton obtained by quantizing a gravity wave, so that the present invention provides a method of employing electromagnetic waves to control a gravity field. In addition, the above-mentioned conversion formula leads to the conclusion that the classical self-energy of electrical charge does not grow larger.

Accordingly, the present invention can be utilized for a wide range of technologies including conveying machines and tools that employ an artificially produced gravity field, an attitude controller for a rocket, construction technology using an effect caused by reduced gravity, and aircraft capable of vertical takeoff and landing by control of a gravity field.

According to a most important aspect of the invention, energy operator (Hamiltonian operator) is applied to a wave function having the reference wave motion, and the wavelength of this reference wave motion is calculated both when a material particle is moving and when it is not moving, and that wavelength at the time of its motion is compared with the same wavelength during its rest, so that one may obtain the special theory of relativity from the reference wave motion. If coordinate transformation on the instantaneous equivalence principle is used to calculate the line elements of a static, spherically symmetrical gravity field, considering both a material particle at rest and light emitted from the surface of that material particle in a radial direction results in deriving Schwarzschild line elements. And if two electromagnetic waves with a phase difference of an angle of 90 degrees between are combined together and the angular momentum of a new wave produced by combing the two electromagnetic waves is calculated using the torque given to the electrical charge in space, then one can determine whether the new wave is a photon with a spin of one. Then, one can generate one other photon with an electric field and a magnetic field differing from that new wave by 180 degrees in their phase angles, and further can combine the two photons together in order to decide whether the displacement of a new photon generated by combining those two photons is invariable relative to a rotation by an angle of 180 degrees. And if it proves invariable, one can conclude that that new photon is a graviton with a spin of two.

### DETAILED DESCRIPTION OF THE PREFERRED EMBODIMENT

Upon applying an energy operator (Hamiltonian operator) to a wave function with a reference wave motion, the inventor found that a material particle at rest has a rest energy of mc² (where “m” represents mass, and “c” the velocity of light). Then he calculated the wavelength of the reference wave motion both when a material particle was moving and when it was not moving, and compared that wavelength at the time of its motion and the same wavelength at the time of its rest, with the result that the slowing down of time of a body in motion, the contraction of space, an increase in mass, and so forth became apparent to him. The values of these phenomena were exactly the same as those derived from the special theory of relativity. This indicates that the reference wave motion gives rise to the special theory of relativity.

Also, when the inventor calculated the line element of a static, spherically symmetrical gravity field by doing coordinate transformation on the instantaneous equivalence principle, he considered a material particle at rest and, as a result, he could obtain a coefficient of that line element in its direction of time axis. Further, at the time of that calculation, he considered light emitted from the surface of that material particle in its radial direction and, as a result, could derive a coefficient of the same line element in its radial direction. As a result, he found that any line element with the above-mentioned two coefficients is nothing else but the Schwarzschild line elements. That is to say, the principle disclosed by this invention indicates that the general theory of relativity is correct.

Moreover, the inventor hereof combined two electromagnetic waves with a phase difference of 90 degrees between, and used a torque that a whole wave produced by combining the two waves together gave to the electrical charge in space, in order to calculate the angular momentum of the whole wave and, as a result, it became apparent that this whole wave is a photon having an angular momentum of a spin of one.

This electromagnetic wave will be referred to as a first wave below. Then, he generated one other photon with an electric field and a magnetic field differing from the first wave by 180 degrees in its phase angle, and combined the two photons together, with the result that displacement similar to that in quadrupole occurred. This displacement was invariable relative to a rotation by an angle of 180 degrees. Then, he further quantized a new electromagnetic wave as obtained by combining the two photons, with the result that a graviton with an angular momentum of a spin of two was derived.

Accordingly the theory of this invention is effective in employing gravity, in lieu of electromagnetic force, as motive power, and hence can contribute towards a wide range of such technologies as conveying machines and tools that use an artificially produced gravity field, an attitude controller for a rocket, construction technology utilizing an effect caused by reduced gravity, and aircraft capable of vertical takeoff and landing by control of a gravity field.

What is claimed is:

1. A method for unifying light and gravity field using a linear field of gravity in order to use gravity, in lieu of electromagnetic force, as motive power, wherein, that a material particle at rest has a rest energy mc² is proved by adding, to Schrödinger's wave equation, a wave number obtained from a wave motion called a reference wave motion in De Broglie's material wave which defines the wave length of a wave motion generated on the basis of the kinetic momentum of an object moving through space, and the slowing down of time of a body in motion, the contraction of space and the increase of mass as demonstrated by the special theory of relativity are made understandable by employing a wave length of said reference wave motion as an index of the velocity of time and the largeness of space at a place where a material particle “m” exists.

2. A method in accordance with claim 1 wherein the employment of said wave length of said reference wave motion as said index of the velocity of time and the largeness of space at said place where said material particle “m” exists enables one to do instantaneous coordinate transformation at an equal speed on a principle called an instantaneous equivalence principle using the concept of escape velocity in astronomy, so that one may change a gravity field into a zero-gravity field.

3. A method in accordance with claim 2 wherein Schwarzschild's line elements in the general theory of relativity are derived by using both said instantaneous equivalence principle and the velocity of light in the gravity field.

4. A method in accordance with claim 3 wherein the velocity of light and Planck's constant “h” are proportional to each other in said gravity field.

5. A method in accordance with any one of claims 1 and 2 wherein there is derived a coordinate transformation called a super light speed Lorentz transformation that instructs one how to do coordinate transformation when the speed of a moving body is higher than that of light, by using of said wave length of said reference wave motion as said index of the velocity of time and the largeness of space at said place where said material particle “m” exists, and, further, said super light speed Lorentz transformation is employed to derive a modified potential energy of universal gravitation and establish a modified formula for universal gravitation which demonstrate that a self-energy generated by the gravity of a particle having no magnitude, no size, or no dimensions coincides with rest energy without increasing to infinity.

6. A method in accordance with any one of claims 1 to 5 wherein, with regard to said linear field of gravity, a formula for making conversion between electrical charge and mass which shows that the classical self-energy of electrical charge does not grow larger is established on the assumption that gravity wave is a kind of electromagnetic wave, and said formula is used to derive a linear equation of gravity field from Maxwell's electromagnetic field equations.

7. A method in accordance with claim 6 wherein when said assumption is made, two electromagnetic waves with a phase difference of an angle of 90 degrees between are combined together to generate a first photon having a spin of one and, in addition, a second photon with an electric field and an magnetic field differing from said first photon by 180 degrees in its phase angle is generated, and said first and second photons are combined together to obtain a graviton with a spin of two only by the combination of said two electromagnetic waves.
